(19) United States
(12) Patent Application Publication
(10) Pub. No.: US 2012/0306196 A1
(43) Pub. Date: Dec. 6, 2012

(54) ANTI-BACK OFF DEVICE FOR DOWN HOLE TOOLS AND DRIVE SYSTEMS

(75) Inventors: Lokesh Bhatia, Houston, TX (US); Kevin Harrington, Houston, TX (US); Justin Scott, Houston, TX (US); Robert H. Slaughter, JR., Spring, TX (US)

(73) Assignee: SMITH INTERNATIONAL, INC., Houston, TX (US)

(21) Appl. No.: 13/485,321

(22) Filed: May 31, 2012

Related U.S. Application Data
(60) Provisional application No. 61/492,189, filed on Jun. 1, 2011.

(51) Int. Cl. F16L 39/00

(52) U.S. Cl. 285/321

(57) ABSTRACT

A percussion drilling assembly for drilling a borehole, the assembly including a tubular casing having a central axis defined therethrough and a lower end, a driver sub having an upper end threadingly engaged with the lower end of the tubular casing, and an annular locking member disposed between the tubular easing and the driver sub. The annular locking member is configured to engage the tubular casing and the driver sub, and is configured to prevent separation of the driver sub from the tubular casing. The annular locking member includes a deformable elongate member.

### CROSS-REFERENCE TO RELATED APPLICATIONS

This application claims priority under 35 U.S.C. §119(e) to U.S. Provisional Application Ser. No. 61/492,189, filed on Jun. 1, 2011, which is hereby incorporated in its entirety.

### BACKGROUND

In percussion or hammer drilling operations, a drill bit mounted to the lower end of a drill string simultaneously rotates and impacts the earth in a cyclic fashion to crush, break, and loosen formation material. In such operations, the mechanism for penetrating the earthen formation is of an impacting nature, rather than shearing. The impacting and rotating hammer bit engages the earthen formation and proceeds to form a borehole along a predetermined path toward a target zone. The borehole created will have a diameter generally equal to the diameter or “gage” of the drill bit.

Referring to FIG. 1, a conventional percussion drilling assembly 10 for drilling through formations of rock to form a borehole is shown. As shown, the percussion drilling assembly 10 is connected to the lower end of a drill string 11 and includes a top sub 20, a driver sub 40, a tubular casing 30 axially disposed between the top sub 20 and the driver sub 40, a piston 35 slidingly disposed in the tubular casing 30, and a hammer bit 60 slidingly received by the driver sub 40. A feed tube 50 extends between the top sub 20 and the piston 35.

Further, as shown in FIG. 1, the upper end of the top sub 20 is threadingly coupled to the lower end of the drill string 11, and the lower end up top sub 20 is threadingly coupled to the upper end of the tubular casing 30. Furthermore, the lower end of the tubular casing 30 is threadingly coupled to the upper end of driver sub 40. As shown, a hammer bit 60 slidingly engages driver sub 40. A series of generally axial mating splines 61, 41 on the hammer bit 60 and the driver sub 40, respectively, allow the hammer bit 60 to move axially relative to the driver sub 40, while simultaneously allowing the driver sub 40 to rotate the hammer bit 60 with the drill string 11 and the tubular casing 30.

During drilling operations, a compressed fluid, e.g., compressed air, compressed nitrogen, etc., is delivered down the drill string 11 from the surface to the percussion drilling assembly 10. In most cases, the compressed fluid is provided by one or more compressors at the surface. The compressed fluid serves to actuate piston 35 within the tubular casing 30. As the piston 35 moves reciprocally, e.g., along a central axis 15, within the tubular casing 30, it cyclically impacts the hammer bit 60, which, in turn, cyclically impacts the formation to gouge, crush, and break the formation with the cutting elements mounted thereon. The compressed fluid ultimately exits a bit face 64 and serves to flush cuttings away from the bit face to the surface through the annulus between the drill string and the borehole sidewall.

In oil and gas drilling, the cost of drilling a borehole is very high, and is proportional to the length of time it takes to drill to the desired depth and location. The time required to drill the well, in turn, is greatly affected by the number of times the drill bit must be changed before reaching the targeted formation. This is the case because each time the bit is changed, the entire string of drill pipe, which may be miles long, must be retrieved from the borehole, section by section. Once the drill string has been retrieved and the new bit installed, the bit must be lowered to the bottom of the borehole on the drill string, which again must be constructed section by section. As is thus obvious, this process, known as a “trip” of the drill string, requires considerable time, effort and expense.

As described above, in conventional bits, the driver sub 40 is threadingly coupled to the lower end of the tubular casing 30. During drilling, repeated impacts and vibration of the percussion drilling assembly 10 occasionally results in the inadvertent unthreading of the driver sub 40 from the tubular casing 30, resulting in the complete disengagement of the driver sub 40 and the hammer bit 60 from the remainder of the percussion drilling assembly 10 and the drill string 11. Although a bit retainer ring 34 and a retainer sleeve 70 may help restrict the hammer bit 60 from disengaging the driver sub 40, they typically do not restrict the unthreading and disengagement of the driver sub 40 from the tubular casing 30.

Once the driver sub 40 and the drill bit 60 are decoupled from the remainder of the percussion drilling assembly 10, the entire drill string 11 must be pulled to replace the dropped bit 60. Further, a fishing operation may be required to retrieve a dropped bit (e.g., the hammer bit 60). Such tripping and fishing operations undesirably increase the time and cost required to complete the borehole.

Accordingly, there is a need for devices and methods that reduced the likelihood of inadvertent unthreading of the driver sub and case of a percussion drilling assembly.

### SUMMARY

According to one aspect of the present disclosure, a percussion drilling assembly for drilling a borehole includes a tubular casing having a central axis defined therethrough and a lower end, a driver sub having an upper end threadingly engaged with the lower end of the tubular casing, and an annular locking member disposed between the tubular casing and the driver sub. The annular locking member is configured to engage the tubular casing and the driver sub, and is configured to prevent separation of the driver sub from the tubular casing. The annular locking member comprises a deformable elongate member.

According to another aspect of the present disclosure, a method for drilling a borehole includes assembling a percussion drilling assembly on a drill string, in which the assembly includes a tubular casing coupled to the drill string having a central axis defined therethrough, and a driver sub having an upper end threadingly coupled to a lower end of the tubular casing, inserting an annular locking member into a space between the tubular casing and the driver sub, wherein rotation of the driver sub relative to the tubular casing is restricted with the annular locking member disposed about the driver sub, i.e., in the space between the tubular casing and the driver sub. The annular locking member includes a deformable elongate member.

According to another aspect of the present disclosure, a drilling assembly for drilling a borehole includes a first component having a central axis defined therethrough and a first end and a second end, a second component having a first end and a second end, wherein the first end of the second component is threadingly engaged with the second end of the first component, and an annular locking member disposed in a space formed between the first component and the second component, radially outward of the first component. The annular locking member is configured to engage the first component and the second component, and is configured to restrict the rotation of the first component relative to the second component about the central axis. The annular locking member includes a deformable elongate member.

Other aspects and advantages of the disclosure will be apparent from the following description and the appended claims.

### BRIEF DESCRIPTION OF DRAWINGS

FIG. 1 shows a cross-sectional view of a conventional percussion drilling assembly connected to the lower end of a drill string.

FIGS. 2A-2B show multiple cross-sectional views of a percussion assembly according to embodiments disclosed herein.

FIGS. 3A-3D show multiple views of a driver sub according to embodiments disclosed herein.

FIG. 4 shows a transparent, perspective view of a tubular casing having an opening formed in an outer surface of the tubular casing according to embodiments disclosed herein.

FIGS. 5A-5C show multiple views of a drilling assembly according to embodiments disclosed herein.

FIG. 6 shows a perspective view of an annular locking member prior to insertion into a drilling assembly according to embodiments disclosed herein.

FIGS. 7A-7B show perspective views of annular locking members after insertion into a drilling assembly according to embodiments disclosed herein.

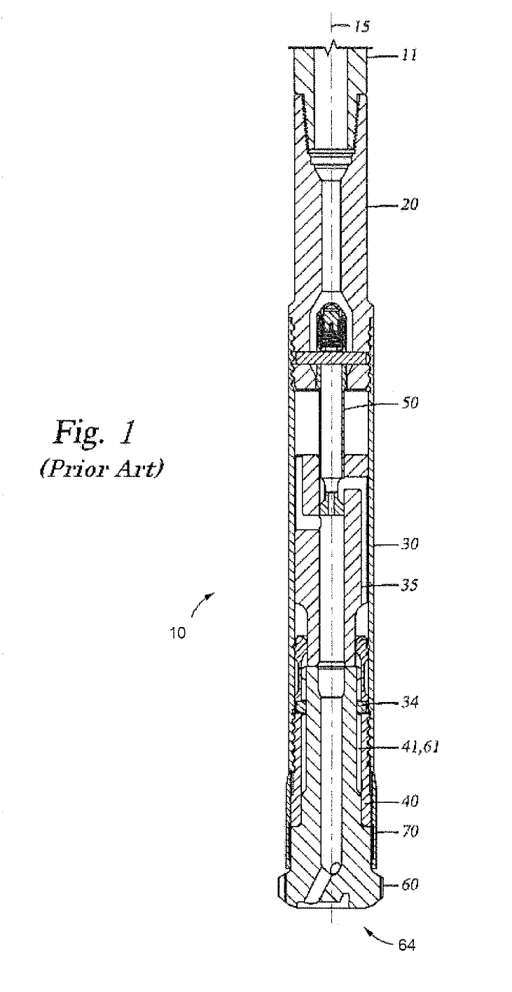

### DETAILED DESCRIPTION

The following is directed to various exemplary embodiments of the disclosure. Although one or more of these embodiments may be preferred, the embodiments disclosed should not be interpreted, or otherwise used, as limiting the scope of the disclosure, including the claims. In addition, those having ordinary skill in the art will appreciate that the following description has broad application, and the discussion of any embodiment is meant only to be exemplary of that embodiment, and not intended to suggest that the scope of the disclosure, including the claims, is limited to that embodiment.

Certain terms are used throughout the following description and claims to refer to particular features or components. As those having ordinary skill in the art will appreciate, different persons may refer to the same feature or component by different names. This document does not intend to distinguish between components or features that differ in name but not function. The figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . .” Also, the term “couple” or “couples” is intended to mean either an indirect or direct connection. Thus, if a first component is coupled to a second component, that connection may be through a direct connection, or through an indirect connection via other components, devices, and connections. Further, the terms “axial” and “axially” generally mean along or parallel to a central or longitudinal axis, while the terms “radial” and “radially” generally mean perpendicular to a central longitudinal axis.

Additionally, directional terms, such as “above,” “below,” “upper,” “lower,” etc., are used for convenience in referring to the accompanying drawings. In general, “above,” “upper,” “upward,” and similar terms refer to a direction toward the earth's surface from below the surface along a borehole, and “below,” “lower,” “downward,” and similar terms refer to a direction away from the surface along the borehole, i.e., into the borehole, but is meant for illustrative purposes only, and the terms are not meant to limit the disclosure.

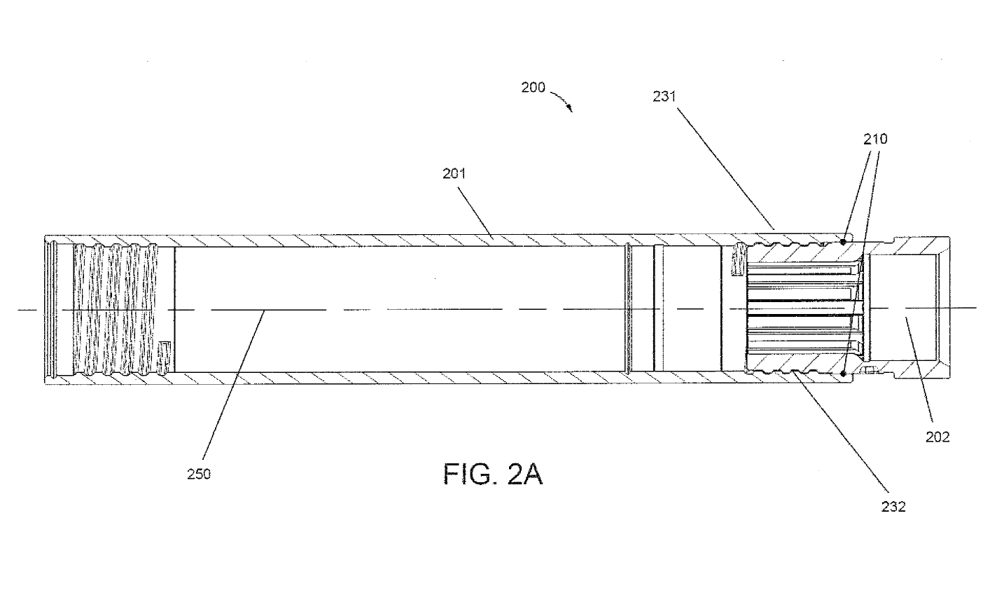

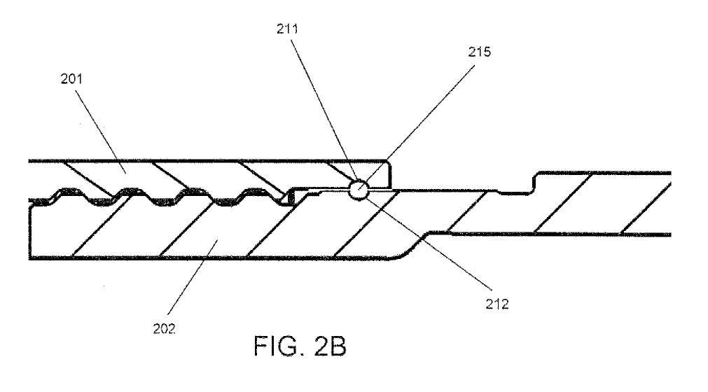

Referring now to FIG. 2A, a cross-sectional, side view of a percussion drilling assembly 200 for drilling a borehole, in accordance with embodiments disclosed herein, is shown. As shown, the percussion drilling assembly 200 includes a tubular casing 201, a driver sub 202, and an annular locking member 210. In one or more embodiments, the tubular casing 201 may have a central axis 250 defined therethrough and a lower end 231. Further, in one or more embodiments, the driver sub 202 may have an upper end 232 threadingly engaged with the lower end 231 of the tubular casing 201. As shown, the upper end 232 of the driver sub 202 may include male threads that are configured to engage with female threads of the lower end 231 of the tubular casing 201. However, those having ordinary skill will appreciate that alternative structures and arrangements may be used to connect the tubular casing 201 with the driver sub 202 without departing from the scope of the present disclosure. For example, instead of male threads, the driver sub 202 may include female threads. The female threads may be used to engage the corresponding connecting configuration featured on the tubular casing 201, such as male threads on the tubular casing 201.

Still referring to FIG. 2A, the annular locking member 210 may be disposed between the tubular casing 201 and the driver sub 202, about the upper end 232 of the driver sub 202. In one or more embodiments, the annular locking member 210 may be configured to engage with the tubular casing 201 and the driver sub 202, and may be configured to prevent separation of the driver sub 202 from the tubular casing 201, or restrict the rotation of the driver sub 202 relative to the tubular casing 201 about the central axis 250. Furthermore, in one or more embodiments, the annular locking member 210 includes a deformable elongate member, such as an annealed mild steel nail or a retention nail for retaining threaded connections. The deformable elongate member may be shearable at a predetermined load. Although the annular locking member 210 may be cylindrical in shape, those having ordinary skill in the art will appreciate that the annular locking member 210 may be one of a variety of shapes or forms. For example, the cross-section of the annular locking member may be circular, elliptical, square, triangular, hexagonal, or any other shape known in the art. Further, in one or more embodiments, the annular locking member 210 may be formed of steel or other malleable, shearable materials. For example, the annular locking member 210 may be formed of brass, 1018 steel, or 1006 steel. In one or more embodiments, the percussion drilling assembly 200 may include a hammer bit (not shown) extending coaxially, along the central axis 250, through the driver sub 202. In one or more embodiments, an acceptable shear strength of the annular locking member 210 may be equivalent to the make-up torque required to make-up the tubular casing 201 and the driver sub 202.

Referring now to FIG. 2B, an inner surface of the tubular casing 201 may include a first groove 211. Further, as shown, an outer surface of the driver sub 202 may include a second groove 212, in which the first groove 211 of the tubular casing 201 and the second groove 212 of the driver sub 202 are axially aligned along a central axis (e.g., central axis 250 of FIG. 2A). In one or more embodiments, a space 215 may be formed between the first groove 211 of the tubular casing 201 and the second groove 212 of the driver sub 202. Further, in one or more embodiments, an annular locking member (not shown) may be disposed in the space 215 formed between the first groove 211 of the tubular casing 201 and the second groove 212 of the driver sub 202, as discussed below. In one or more embodiments, each of the first groove 211 of the tubular casing 201 and the second groove 212 of the driver sub 202 may be configured to receive the annular locking member 210. In other words, the shape, or profile, of each of the first groove 211 of the tubular casing 201 and the second groove 212 of the driver sub 202 may match the shape, or profile, of the annular locking member 210. Those having ordinary skill in the art will appreciate that, like the annular locking member 210, each of the first groove 211 of the tubular casing 201 and the second groove 212 of the driver sub 202 may be one of a variety of shapes or forms. For example, the shape, or profile, of each of the first groove 211 of the tubular casing 201 and the second groove 212 of the driver sub 202 may be circular, elliptical, square, triangular, hexagonal, or any other shape known in the art. Further, in one or more embodiments, each of the first groove 211 of the tubular casing 201 and the second groove 212 of the driver sub 202 may include an edge, or lip (not shown), for facilitating shearing of the annular locking member 210 during disassembly.

Referring, generally, to FIGS. 2A and 2B, the first groove 211 of the tubular casing 201 may extend circumferentially within the tubular easing 201, and the second groove 212 of the driver sub 202 may extend circumferentially about the driver sub 202. In other words, the first groove 211 of the tubular casing 201 may extend within the tubular casing 201 on a plane that is substantially perpendicular, or orthogonal, to the central axis 250. Similarly, the second groove 212 of the driver sub 202 may extend about the driver sub 202 on a plane that is substantially perpendicular, or orthogonal, to the central axis 250. In one or more embodiments, the first groove 211 of the tubular casing 201 may extend substantially 300 degrees circumferentially within the tubular casing, and the second groove 212 of the driver sub 202 may extend substantially 300 degrees circumferentially about the driver sub 202. However, those having ordinary skill in the art will appreciate that the first groove 211 and the second groove 212 may extend more or less than 300 degrees within the tubular casing 201 and about the driver sub 202, respectively. For example, in one or more embodiments, the first groove 211 and the second groove 212 may extend 250 degrees within the tubular casing 201 and about the driver sub 202, respectively. Further, in one or more embodiments, the first groove 211 and the second groove 212 may extend up to 350 degrees, and in some embodiments up to 360 degrees, within the tubular casing 201 and about the driver sub 202, respectively.

Alternatively, in one or more embodiments, the first groove 211 may extend helically within the tubular casing 201, and the second groove 212 may extend helically about the driver sub 202. In other words, the first groove 211 of the tubular casing 201 and the second groove 212 of the driver sub 202 may have a spiral-shape that may extend along the central axis 250 within the tubular casing 201 and about the driver sub 202, respectively. Further, the first groove 211 of the tubular casing 201 and the second groove 212 of the driver sub 202 may have a spiral-shape that may extend more than 360 degrees within the tubular casing 201 and about the driver sub 202, respectively. As such, in one or more embodiments, the annular locking member 210 disposed between a helically-extending first groove 211 and a helically-extending second groove 212 may overlap itself in the direction of the central axis 250.

Although, as shown in FIGS. 2A and 2B, the first groove 211 of the tubular casing 201 and the second groove 212 of the driver sub 202 may be formed below the threaded connection portions on the lower end and the upper end 231, 232 of the tubular casing 201 and the driver sub 202, respectively, those having ordinary skill in the art will appreciate that the first groove 211 of the tubular casing 201 and the second groove 212 of the driver sub 202 may be formed on any part of the tubular casing 202 and the driver sub 202 such that the first groove 211 and the second groove 212 may be axially aligned. For example, both the first groove 211 and the second groove 212 may be formed above the threaded connection portions of the tubular casing 201 and the driver sub 202. As a result, the annular locking member 210 may be engaged with the tubular casing 201 and the driver sub 202 above the threaded connection portions of the tubular casing 201 and the driver sub 202. Further, those having ordinary skill in the art will appreciate that the first groove 211 and the second groove 212 may be formed on any part of a downhole tool, particularly, those parts with threaded connections, and may not be necessarily limited to being formed on a tubular casing or a driver sub (e.g., tubular casing 201 and driver sub 202). For example, the first groove 211 and the second groove 212 may be formed on a top sub (not shown) and a second tubular casing (not shown), respectively, either above or below the threaded connection portions of the top sub or the second tubular casing. As a result, the annular locking member 210 may be engaged with the top sub and the second tubular casing, or between any other threadedly connected downhole components, either above or below the threaded connection portions.

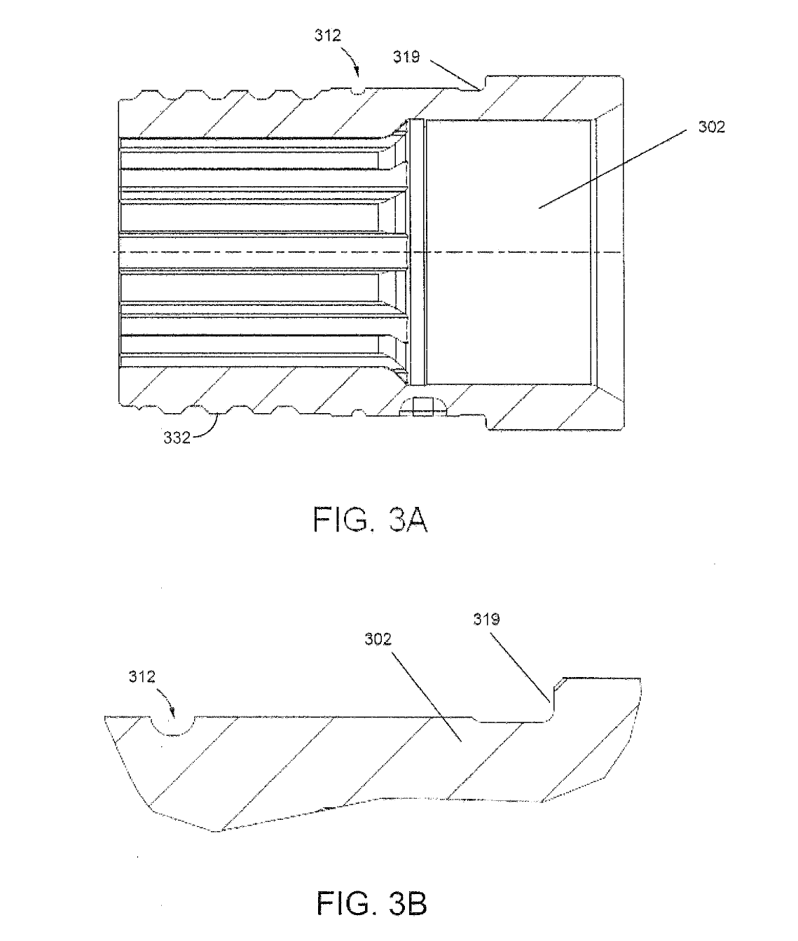

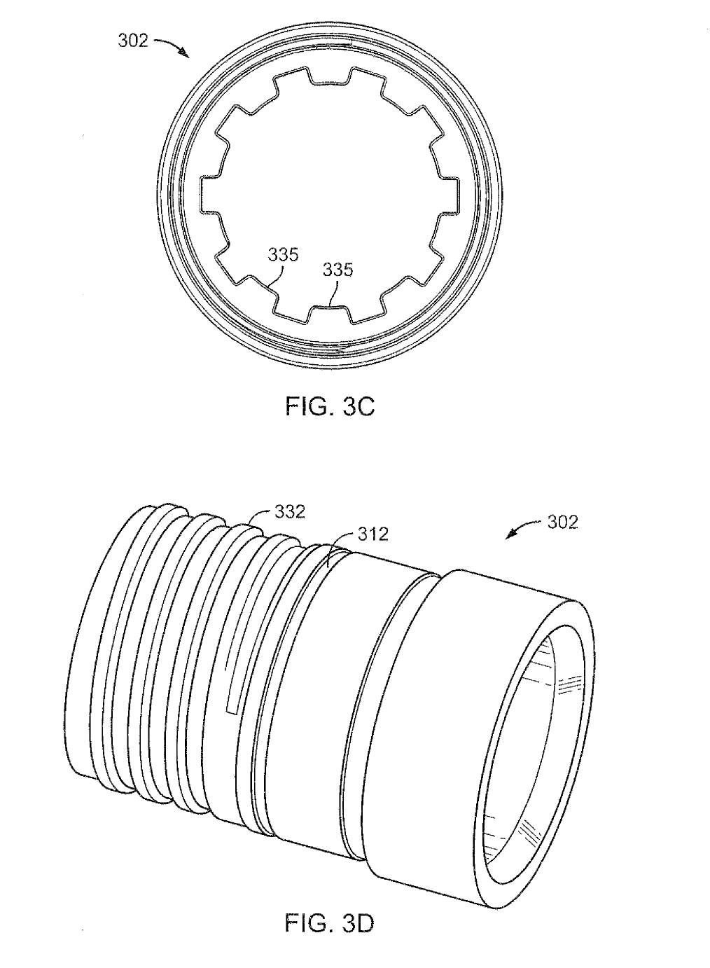

Referring to FIGS. 3A-3D, multiple views of a driver sub 302, in accordance with embodiments disclosed herein, are shown. FIG. 3A shows the driver sub 302 having second groove 312, male threads 332, and a shoulder 319. FIG. 3B shows a closer view of the second groove 312 and the shoulder 319 of the driver sub 302. As discussed above, in one or more embodiments, the second groove 312 of the driver sub 302 may be configured to be axially aligned, or mated, with a corresponding first groove (not shown) of a tubular casing (not shown). Further, as discussed above, in one or more embodiments, the tubular casing may include corresponding female threads that may be configured to engage with the male threads 332 of the driver sub 302. In one or more embodiments, the shoulder 319 of the driver sub 302 may be configured to engage at least a portion (e.g., a bottom portion) of the tubular casing. An engagement between the shoulder 319 of the driver sub 302 and a bottom portion of the tubular casing may allow the first groove of the tubular casing and the second groove 312 of the driver sub 302 to be axially aligned. In other words, the first groove of the tubular casing and the second groove 312 of the driver sub 302 may be formed such that engagement between the shoulder 319 of the driver sub 302 and the bottom portion, or surface, of the tubular casing may ensure that the first groove of the tubular casing is axially aligned with the second groove 312 of the driver sub 302.

As shown in FIG. 3C, in one or more embodiments, the driver sub 302 may include splines 335. The splines 335 of the driver sub 302 may engage with corresponding, mating, splines (not shown) of a drill bit, e.g., a hammer bit (not shown). The splines 335 of the driver sub 302 may engage with the corresponding, mating splines of the hammer bit, and may allow the hammer bit to move axially relative to the driver sub 302, while simultaneously allowing the driver sub 302 to rotate the hammer bit with a drillstring (not shown). As a result, the drill string rotation may be transferred through the driver sub 302, to the hammer bit.

Referring to FIG. 3D, a perspective view of the driver sub 302, in accordance with embodiments disclosed herein, is shown. The driver sub 302 includes the second groove 312 formed about the driver sub 302 and male threads 332. As discussed above, in one or more embodiments, the second groove 312 of the driver sub 302 may be configured to axially align, or mate, with a corresponding first groove (not shown) of a tubular casing (not shown). Further, as discussed above, in one or more embodiments, the tubular casing may include corresponding female threads configured to engage with the male threads 332 of the driver sub 302.

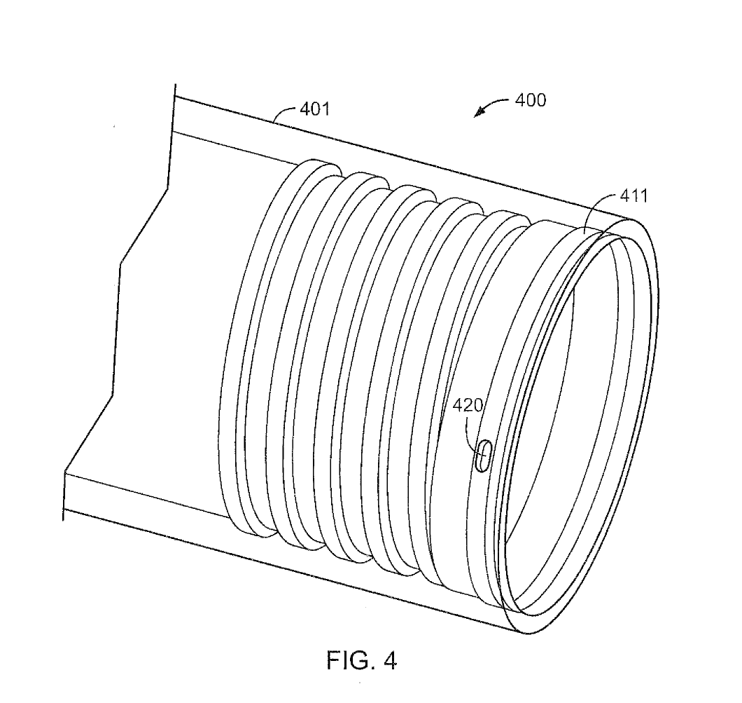

Referring to FIG. 4, a transparent, perspective view of a tubular casing 401 having an opening 420 formed in an outer surface of the tubular casing 401, in accordance with embodiments disclosed herein, is shown. In one or more embodiments, the opening 420 may be formed in the outer surface of the tubular casing 401 and may be aligned with a first groove 411 of the tubular casing 401. For example, the opening 420 may be formed in the casing tangent to the first groove 411. The opening 420 is in communication with the first groove 411 such that the opening 420 allows access to a space (see, e.g., 215 of FIG. 2B) formed between the first groove 411 of the tubular casing 401 and a second groove (not shown) of a driver sub (not shown). In one or more embodiments, the opening 420 may be configured to receive an annular locking member (not shown). As such, in one or more embodiments, the annular locking member may be inserted, or disposed, through the opening 420 after the tubular casing 401 and the driver sub are assembled, into the space formed between the first groove 411 of the tubular casing 401 and the second groove of the driver sub. As discussed above, inserting, or disposing, the annular locking member into the space formed between the first groove 411 of the tubular casing 401 and the second groove of the driver sub may provide a locking or retention mechanism, which may resist back-off, unthreading, or separation between the driver sub and the tubular casing 401, due to vibration or other conditions while drilling. Those having ordinary skill in the art will appreciate that the opening 420 may be formed in the outer surface of the tubular casing 401 such that the annular locking member may be inserted in either a clockwise direction or a counter-clockwise direction about the driver sub. Further, once the annular locking member is inserted, or disposed, within the opening 420, the opening 420 may be sealed with plugs (not shown) or with a resin or filling (not shown), e.g, silicon. The plugs may be threaded or press-fit into the opening 420.

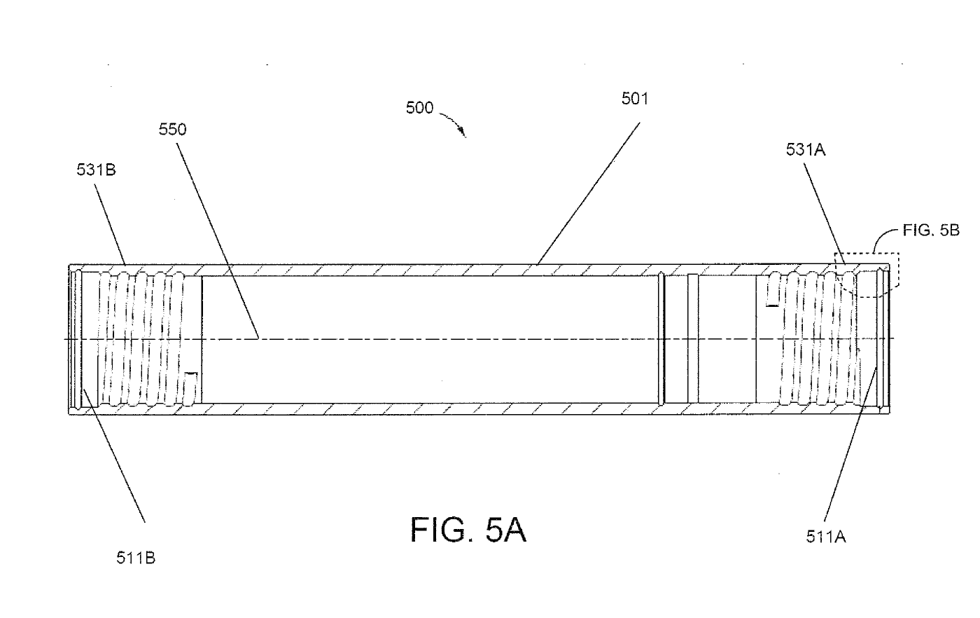

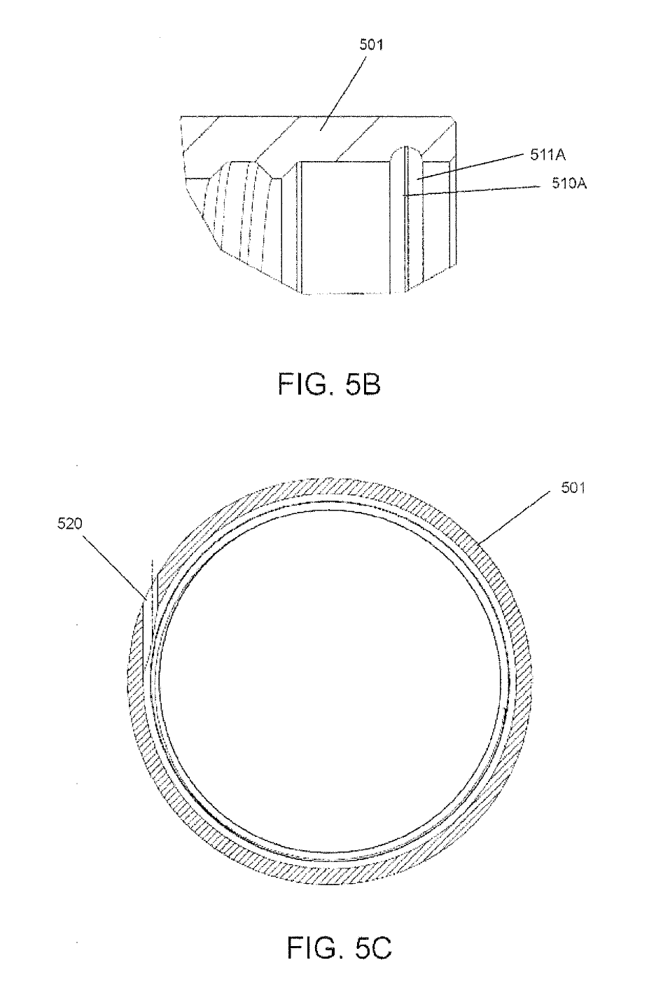

Referring to FIGS. 5A-5C, multiple views of a drilling assembly 500, in accordance with embodiments disclosed herein, are shown. The drilling assembly 500 may include a first component 501 and a second component (not shown), the first component having at least one first groove 511A, 511B, and the second component having at least one second groove (not shown), which may be configured to axially align with the at least one first groove 511A, 511B of the first component. In one or more embodiments, the first component 501 may include a central axis 550 defined therethrough and a first end and a second end. Further, in one or more embodiments, the second component may include a first end and a second end, in which the first end of the second component may be threadingly engaged with the second end of the first component 501. As shown, the first component 501 includes female threads 531A, 531B, in which one set of such threads is configured to engage with the male threads (not shown) of the second component. However, as discussed above, those having ordinary skill in the art will appreciate that alternative structures and arrangements may be used to connect the first component 501 and the second component without departing from the scope of the present disclosure. For example, instead of female threads, the first component 501 may include male threads. The male threads may be used to engage the corresponding connecting configuration featured on the second component, such as female threads on the second component. Those having ordinary skill in the art will appreciate that the first component and the second component of the drilling assembly may be any downhole tool components, which may be coupled together.

Still referring to FIG. 5A, an annular locking member (not shown) may be coupled between the made-up connection of the two components to prevent the connection from separating due to vibration or other downhole conditions. In one or more embodiments, the annular locking member may be disposed in a space formed between the at least one first groove of the first component and the at least one second groove of the second component. Those having ordinary skill in the art will appreciate that one or more annular locking members may be used on a drilling assembly, according to embodiments disclosed herein. For example, a drilling assembly having first grooves 511A, 511B, and corresponding second grooves, may include two annular locking members. Further, a drilling assembly having three first grooves, and corresponding second grooves, may include three annular locking members.

As discussed above, the annular locking member may be disposed between the first component 501 and the second component, about the second component. In one or more embodiments, the annular locking member may be configured to engage with the first component 501 and the second component, and may be configured to prevent separation of the second component from the first component 501, or to restrict the rotation of the second component relative to the first component 501 about the central axis 550. As described above, in one or more embodiments, the annular locking member may include deformable elongate members, such as annealed mild steel nails or retention nails for retaining threaded connections. The deformable elongate members may be shearable at a predetermined load. Further, as discussed above, those having ordinary skill in the art will appreciate that the annular locking member may be one of a variety of shapes or forms. For example, the cross-section of the annular locking member may be circular, elliptical, square, triangular, hexagonal, or any other shape known in the art. Further, in one or more embodiments, the annular locking member may be formed of steel or other malleable, shearable materials. For example, the annular locking member may be formed of brass, 1018 steel, or 1006 steel. Those having ordinary skill in the art will also appreciate that both the first component 501 and the second component may be formed or configured to receive the annular locking member on either side (i.e., above or below) of the threaded connection members 531A, 531B of the first component 501 and threaded connection members/portions of the second component.

As shown in FIG. 5B, the annular locking member 510A may be disposed between the first component 501 and a second component 502 (not shown). As discussed above, in one or more embodiments, a space (partially shown via groove 511A) may be formed between a first groove 511A of the first component 501 and a second groove (not shown) of the second component 502. As shown, the annular locking member 510A is disposed in the space formed between the first groove of the first component 501 and the second groove of the second component 502.

Referring to FIG. 5C, a cross-sectional view of the first component 501, in accordance with embodiments disclosed herein, is shown. The first component 501 has an opening 520 formed in an outer surface of the first component 501. As discussed above, in one or more embodiments, the opening 520 may be formed in the outer surface of the first component 501 and may be aligned with a first groove (not shown) of the first component 501. In other words, the opening 520 may allow access to a space formed between the first groove of the first component 501 and a second groove (not shown) of a second component (not shown). Further, as discussed above, in one or more embodiments, the opening 520 may be configured to receive an annular locking member (not shown). As such, in one or more embodiments, the annular locking member may be inserted, or disposed, through the opening 520, into the space formed between the first groove of the first component 501 and the second groove of the second component. As the annular locking member is inserted, the annular locking member bends or deforms as a first end of the annular locking member contacts the groove, e.g., the first groove of the first component 501 and/or the second groove of the second component. The annular locking member is forced into a ring-like configuration as it is inserted into the groove and moved around the second component. As discussed above, inserting, or disposing, the annular locking member into the space formed between the first groove of first component 501 and the second groove of the second component may provide a locking or retention mechanism, which may resist back-off, unthreading, or separation, between the second component and the first component 501, due to vibration or other conditions while drilling.

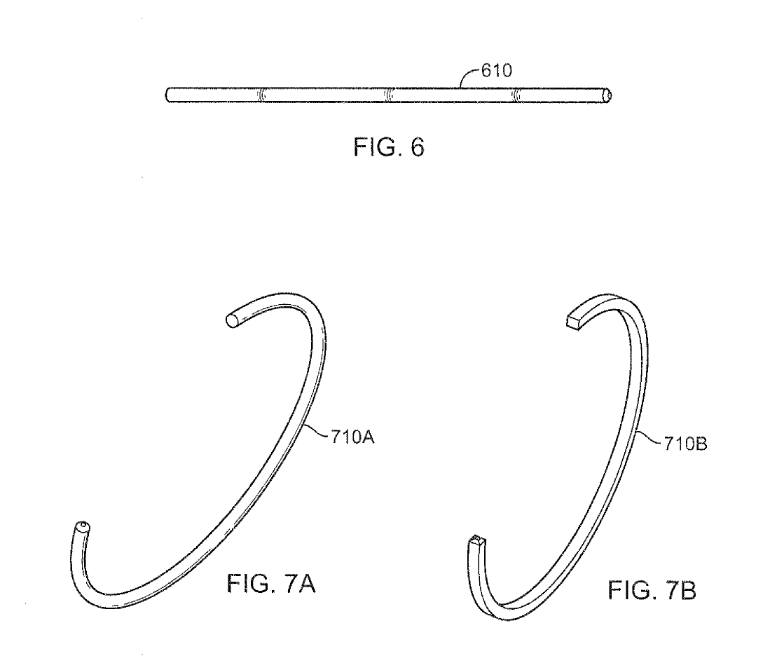

Referring to FIG. 6, an annular locking member 610 is shown prior to insertion into a drilling assembly, in accordance with embodiments disclosed herein. As shown, the annular locking member 610 has a circular cross-section. As discussed above, those having ordinary skill in the art will appreciate that the annular locking member 610 may be one of a variety of shapes or forms. For example, the cross-section of the annular locking member may be circular, elliptical, square, triangular, hexagonal, or any other shape known in the art. Further, in one or more embodiments, the annular locking member 610 may be a deformable, elongate member and may be formed of a steel or other malleable, shearable material. For example, the annular locking member may be formed of brass, 1018 steel, and/or 1006 steel. As shown, the annular locking member 610 may be substantially straight prior to insertion into a drilling assembly (not shown), However, those having ordinary skill in the art will appreciate that the annular locking member 610 may not necessarily be substantially straight prior to insertion into the drilling assembly. For example, the annular locking member may be bent, curved, or angled prior to insertion into the drilling assembly.

Referring to FIGS. 7A-7B, annular locking members 710A, 710B after insertion into a drilling assembly, in accordance with embodiments disclosed herein, are shown. As shown, annular locking members 710A, 710B have circular and square-shaped cross-sections, respectively. As discussed above, those having ordinary skill in the art will appreciate that the annular locking members 710A, 710B may be one of a variety of shapes or forms. Further, as discussed above, in one or more embodiments, the annular locking members 710A, 710B may be deformable, elongate members and may be formed of steel or other malleable, shearable materials. As shown, the annular locking members 710A, 710B may be in a ring-like configuration after insertion into a drilling assembly (not shown), because the annular locking members 710A, 710B are forced to bend, or deform, when inserted into the drilling assembly. However, those having ordinary skill in the art will appreciate that the annular locking members 710A, 710B may be formed into a variety shapes after insertion into a drilling assembly. For example, in one or more embodiments, the annular locking members 710A, 710B may be forced or formed to the shape of a space formed between a first groove of a first component (not shown), e.g., a tubular casing, and a second groove of a second component (not shown), e.g., a driver sub. As discussed above, inserting, or disposing, the annular locking member into the space formed between the first groove of first component and the second groove of the second component may provide a locking or retention mechanism, which may resist back-off, unthreading, or separation, between the second component and the first component, due to vibration or other conditions while drilling.

A method for drilling a borehole, in accordance with embodiments disclosed herein, may include assembling a percussion drilling assembly on a drill string, in which the assembly includes a tubular casing coupled to the drill string having a central axis defined therethrough, and a driver sub having an upper end threadingly coupled to a lower end of the tubular casing, inserting an annular locking member into a space between the tubular casing and the driver sub, in which rotation of the driver sub relative to the tubular casing is restricted with the annular locking member disposed about the driver sub (i.e., in the space between the tubular casing and the driver sub). The annular locking member includes a deformable elongate member.

For example, referring back to FIGS. 2A-2B, the percussion drilling assembly 200 may include the tubular casing 201 coupled to a drill string (not shown) having a central axis 250 defined therethrough, and a driver sub 202 having an upper end 232 threadingly coupled to a lower end 231 of the tubular casing 201. The annular locking member 210 may be inserted into a space 215 between the tubular casing 201 and the driver sub 202. Further, the rotation of the driver sub 202 relative to the tubular casing 201 may be restricted by the annular locking member 210 disposed about the driver sub 202.

The method may also include axially aligning the first groove 211 of the tubular casing 201 and the second groove 212 of the driver sub 202, in which the space 215 is formed between the first groove 211 of the tubular casing 201 and the second groove 212 of the driver sub 202. As discussed above, as shown in FIGS. 2A-2B, the tubular member 201 may include a first groove 211, and the driver sub 202 may include a second groove 212, in which the space 215 between the tubular casing 201 and the driver sub 202 is formed between the first groove 211 and the second groove 212. Furthermore, as shown in FIG. 4, the tubular casing 401 may include an opening 420 formed in an outer surface of the tubular casing 401 and aligned with the first groove 411 of the tubular casing 401.

As discussed above, and with reference to FIGS. 2A-2B and 4, the method may include inserting an annular locking member 210 into a space 215 between the tubular casing 201, 401 and the driver sub 202. According to one or more embodiments, inserting an annular locking member 210 into a space 215 between the tubular casing 201, 401 and the driver sub 202 may include inserting the annular locking member 210 within the opening 420 formed in the outer surface of the tubular casing 201, 401 and into the space 215 defined between the first groove 211, 411 of the tubular casing 201, 401 and the second groove 212 of the driver sub 202, deforming the annular locking member 210 into a ring shape around the driver sub 202. Specifically, the material of the annular locking member 210 is selected so as to be sufficiently malleable so that, when inserted through opening 420 and in between the space defined by the grooves 211, 212, the ring bends or deforms so that it wraps around the driver sub 202. The annular locking member 210 may be inserted into the space 215 between the grooves 211, 212 by hammering or applying pressure to a distal end of the annular locking member 210. The material chosen also provides sufficient strength to withstand the vibrations and movement of the drill string. In one or more embodiments, the shear strength of the annular locking member 210 is approximately equal to the make-up torque of the components. Furthermore, the material selected for the annular locking member 210 allows the annular locking member 210 to be sheared upon disassembly. Examples of materials that may be used for the annular locking member 210 include brass, 1018 steel, 1006 steel, or any other material known in the art.

Referring generally to FIGS. 2A-2B and 4, the annular locking member 210 may be inserted, or disposed, into the opening 420 of the tubular casing 201, 401. Inserting or disposing the annular locking member 210 into the opening 420, e.g., into the space formed between the first groove 211, 411 of the tubular casing 201, 401 and the driver sub 202, may cause the annular locking member 210 to deform, or conform to the shape of the space 215 between the first groove 211, 411 of the tubular casing 201, 401 and the driver sub 202. In one or more embodiments, the space 215 between the first groove 211, 411 of the tubular casing 201, 401 and the driver sub 202 may be ring-shaped, e.g., shaped circumferentially about the driver sub 202. As discussed above, the annular locking member 210 may be formed of a malleable, shearable material, such as brass, 1018 steel, and/or 1006 steel, and may be forced to conform to the shape of the space 215 between the first groove 211, 411 of the tubular casing 201, 401 and the driver sub 202. As such, the annular locking member 210 may be disposed about the driver sub 202. As discussed above, the annular locking member 210 may be disposed more or less than 300 degrees about the driver sub 202.

The annular locking member 210 may be inserted into the opening 420 and into space 215 between the tubular casing 201, 401 and the driver sub 202 by forcing the annular locking member 210 into the opening 420 and the space 215 using a hammer or a mallet. However, those having ordinary skill in the art will appreciate that the annular locking member 210 may be inserted or disposed within the opening 420 and the space 215 between the tubular casing 201, 401 and the driver sub 202 by other means other than a hammer or mallet.

The method may also include disengaging the tubular casing 201, 401 from the driver sub 202. In one or more embodiments, disengaging the tubular casing 201, 401 from the driver sub 202 may include shearing the annular locking member 210. For example, referring to FIG. 2A, in order to disengage the tubular casing 201, 401 from the driver sub 202, the annular locking member 210 is sheared. In one or more embodiments, this may be accomplished by applying an appropriate torque on the tubular casing 201, 401 and the driver sub 202 about the central axis 250 in opposite directions. The torque applied is greater than the shear strength of the annular locking member 210. Therefore, when the torque is applied, the annular locking member 210 shears.

As previously described, in some conventional percussion drilling assemblies, the driver sub may inadvertently begin to rotate relative to the tubular casing, resulting in unthreading of the driver sub from the tubular casing. The unthreading of the tubular casing and the driver sub may be triggered by a number of factors including, without limitation, vibrations in the percussion drilling assembly, the driver sub not being torqued to specification relative to the tubular casing, the repeated impacts of the piston and the hammer bit, or combinations thereof. Since most conventional percussion drilling assemblies rely exclusively on proper torquing of the driver sub and resulting friction at the interface of the mating threads on the driver sub and the tubular casing, once unthreading begins it is may continue until the driver sub completely disengages from the case. If the driver sub completely disengages from the tubular casing, the hammer bit and any additional sleeves or casings (e.g., a retainer ring, a retainer sleeve, and/or a guide sleeve) may also become disengaged along with the driver sub. It should be appreciated that, although a retainer ring and a retainer sleeve may prevent the complete disengagement of the hammer bit from the driver sub, a retainer ring and/or a retainer sleeve may not be intended to prevent disengagement of the driver sub from the case in the event of unthreading. Consequently, the inadvertent unthreading and disengagement of the driver sub from the tubular casing typically requires an expensive trip of the drill string, replacement of the hammer bit, and fishing expedition. However, unlike most conventional percussion drilling assemblies, embodiments of percussion drilling assemblies described herein also include an annular locking member disposed about the driver sub. The annular locking member, according to embodiments disclosed herein, may advantageously restrict and/or prevent the relative rotation between tubular casing and the driver sub, thereby providing a mechanical lock that offers the potential to reduce the likelihood of an inadvertent unthreading of driver sub from tubular casing.

Although only a few example embodiments have been described in detail above, those skilled in the art will readily appreciate that many modifications are possible in the example embodiments without materially departing from this invention. Accordingly, all such modifications are intended to be included within the scope of this disclosure. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A percussion drilling assembly for drilling a borehole, the assembly comprising:
a tubular casing having a central axis defined therethrough and a lower end;
a driver sub having an upper end threadingly engaged with the lower end of the tubular casing; and
an annular locking member disposed between the tubular casing and the driver sub, the annular locking member comprising a deformable elongate member,
wherein the annular locking member is configured to engage the tubular casing and the driver sub, and is configured to prevent separation of the driver sub from the tubular casing.

2. The assembly of claim 1, wherein the tubular casing has an inner surface including a first groove,
the driver sub has an outer surface including a second groove, and
the first groove of the tubular casing and the second groove of the driver sub are axially aligned.

3. The assembly of claim 2, wherein the annular locking member is disposed in a space formed between the first groove of the tubular casing and the second groove of the driver sub.

4. The assembly of claim 1, further comprising a hammer bit extending coaxially through the driver sub.

5. The assembly of claim 3, wherein the first groove of the tubular casing extends circumferentially within the inner surface of the tubular casing, and the second groove of the driver sub extends circumferentially within the outer surface of the driver sub.

6. The assembly of claim 3, wherein the first groove of the tubular casing extends helically within the inner surface of the tubular casing, and the second groove of the driver sub extends helically within the outer surface of the driver sub.

7. The assembly of claim 3, wherein the first groove of the tubular casing extends up to 350 degrees circumferentially within the inner surface of the tubular casing, and the second groove of the driver sub extends up to 360 degrees circumferentially within the outer surface of the driver sub.

8. The assembly of claim 3, wherein the first groove of the tubular casing extends more than 360 degrees helically within the inner surface of the tubular casing, and the second groove of the driver sub extends more than 360 degrees helically within the outer surface of the driver sub.

9. The assembly of claim 3, further comprising an opening formed in an outer surface of the tubular casing and aligned with the first groove of the tubular casing, the opening arranged and designed to provide access to the first groove of the tubular casing.

10. The assembly of claim 9, wherein the opening is configured to receive the annular locking member.

11. The assembly of claim 1, wherein the annular locking member is shearable.

12. The assembly of claim 1, wherein a cross-section of the annular locking member is selected from the group consisting of circular, elliptical, square, triangular, and hexagonal.

13. A method for drilling a borehole, the method comprising:
assembling a percussion drilling assembly on a drill string, wherein the assembly comprises:
a tubular casing coupled to the drill string having a central axis defined therethrough; and
a driver sub having an upper end threadingly coupled to a lower end of the tubular casing; and
inserting an annular locking member into a space between the tubular casing and the driver sub, the annular locking member comprising a deformable elongate member,
wherein rotation of the driver sub relative to the tubular casing is restricted with the annular locking member disposed in the space between the tubular casing and the driver sub.

14. The method of claim 13, wherein an inner surface of the tubular casing includes a first groove, and
an outer surface of the driver sub includes a second groove.

15. The method of claim 14, further comprising axially aligning the first groove of the tubular casing and the second groove of the driver sub, wherein the space is formed between the first groove of the tubular casing and the second groove of the driver sub.

16. The method of claim 15, wherein the assembly further comprises an opening formed in an outer surface of the tubular casing and aligned with the first groove of the tubular casing, the opening arranged and designed to provide access to the first groove of the tubular casing.

17. The method of claim 16, wherein inserting an annular locking member into the space between the tubular casing and the driver sub includes inserting the annular locking member into the opening and deforming the annular locking member into the space between the tubular casing and the driver sub.

18. The method of claim 13, further comprising disengaging the tubular casing from the driver sub.

19. The method of claim 18, wherein disengaging the tubular casing from the driver sub includes shearing the annular locking member.

20. An assembly comprising:
a first component having a central axis defined therethrough and a first end and a second end;
a second component having a first end, wherein the first end of the second component is coupled with the second end of the first component; and
an annular locking member disposed in a space formed between the first component and the second component, the annular locking member comprising a deformable elongate member,
wherein the annular locking member is configured to engage the first component and the second component, and is configured to restrict the rotation of the first component relative to the second component about the central axis.

21. The assembly of claim 20, wherein the first component has an outer surface including a first groove,
the second component has an inner surface including a second groove, and
the first groove of the first component and the second groove of the second component are axially aligned.

22. The assembly of claim 21, wherein the annular locking member is disposed in a space formed between the first groove of the first component and the second groove of the second component.
